(19) United States
(12) Patent Application Publication
(10) Pub. No.: US 2026/0109281 A1
(43) Pub. Date: Apr. 23, 2026

(54) VEHICLE AND METHOD OF CONTROLLING VIBRATION OF SEAT

(71) Applicants: Hyundai Motor Company, Seoul (KR); Kia Corporation, Seoul (KR)

(72) Inventors: Ki Chang Kim, Hwaseong (KR); Su In Kim, Hwaseong (KR); Dong Chul Park, Hwaseong (KR)

(21) Appl. No.: 19/205,425

(22) Filed: May 12, 2025

(30) Foreign Application Priority Data
Oct. 17, 2024 (KR) 10-2024-0142117

(51) Int. Cl. B60N 2/90; B60N 2/00

(52) U.S. Cl. CPC B60N 2/90; B60N 2/0022; B60N 2002/981

(57) ABSTRACT

A vehicle includes at least one processor and a memory configured to store at least one program executed by the at least one processor, and the at least one processor is configured to execute the at least one program to determine a driving mode of the vehicle using vehicle traveling information of a sensor unit, analyze a heart rate variability of an occupant using biometric information about the occupant collected from a biometric information collection unit, and control a vibration signal of a vibrator provided on a seat of the vehicle using the driving mode and the heart rate variability.

### CROSS-REFERENCE TO RELATED APPLICATION

This application claims under 35 U.S.C. § 119(a) the benefit of Korean Patent Application No. 10-2024-0142117, filed on Oct. 17, 2024, the entire contents of which are incorporated herein by reference.

### BACKGROUND

### 1. Technical Field

A vehicle and a method of controlling vibration of a seat of the vehicle are operable to control vibration of the seat in order to counteract feelings of motion sickness by an occupant of the vehicle.

### 2. Description of the Related Art

An occupant riding in an autonomous vehicle may perform various non-driving tasks, such as reading a book, using a smartphone, and so on, in the vehicle. However, any such actions also pose the risk of causing motion sickness to the occupant riding in the autonomous vehicle.

Motion sickness, which may be accompanied by dizziness, nausea, or the like, when riding in a vehicle, is caused by temporary confusion that the brain experiences when there is an input mismatch between the sensory organs (visual, vestibular, and the like) that maintain balance or detect movement and posture.

Meanwhile, virtual environment motion sickness (cyber sickness) refers to a motion sickness symptom that occur when using virtual reality (VR), augmented reality (AR), video games, 3D movies, or the like. Cyber sickness may occur due to a mismatch between visual information related to movement and actual physical sensations, and symptoms may appear similar to traditional motion sickness.

In recent years, consumption patterns in the emotional information & communication (ICT) field, which detects and recognizes an occupant's emotions and provides services using IT devices, are increasing. In addition, as autonomous vehicles become more technologically advanced and more widespread, the market for content that may be experienced in vehicles is rapidly expanding.

For this reason, various studies on virtual environment motion sickness caused by a sense of difference between visual and auditory senses when an occupant riding in an autonomous vehicle experiences virtual content are being conducted.

### SUMMARY

The present disclosure is directed to providing a vehicle capable of improving the riding comfort of an occupant while the vehicle is traveling, and a method of controlling the same.

The present disclosure is also directed to providing a vehicle capable of reducing motion sickness of an occupant and a method of controlling the same.

The present disclosure is also directed to providing a vehicle capable of reducing motion sickness caused by sensory conflict due to provision of virtual content under a vehicle occupant environment and a method of controlling the same.

According to the present disclosure, a vehicle includes: at least one processor; and a memory configured to store at least one program executed by the at least one processor, where the at least one processor is configured to execute the at least one program to: determine a driving mode of the vehicle using vehicle traveling information of a sensor unit; analyze a heart rate variability of an occupant using biometric information about the occupant collected from a biometric information collection unit; and control a vibration signal of a vibrator provided on a seat of the vehicle using the driving mode and the heart rate variability.

According to a further aspect of the present disclosure, there is provided a vehicle including one or more processors and a memory configured to store one or more programs executed by the one or more processors, in which the processor includes a first processing unit configured to determine a driving mode of the vehicle using vehicle traveling information of a sensor unit, a second processing unit configured to analyze a heart rate variability of an occupant using biometric information about the occupant collected from a biometric information collection unit, and a third processing unit configured to control a vibration signal of a vibrator provided on a seat of the vehicle using the driving mode and the heart rate variability.

Further, as provided herein, the at least one processor may comprise first, second, and/or third processing units.

The first processing unit may determine the driving mode of the vehicle using speed information and acceleration information included in the vehicle traveling information.

The third processing unit may determine a vibration characteristic of the vibrator based on the driving mode and the heart rate variability.

The third processing unit may determine a vibration frequency, a vibration magnitude, and a vibration time of the vibrator depending on the driving mode and the heart rate variability.

The second processing unit may analyze a weight of the occupant using the biometric information about the occupant collected from the biometric information collection unit, and the third processing unit may adjust the vibration characteristic of the vibrator according to the weight of the occupant.

The third processing unit may adjust the vibration characteristic based on a content signal transmitted to the occupant.

The third processing unit may set an output range of the vibration characteristic according to the content signal.

The third processing unit may independently control vibration characteristics of a plurality of vibrators provided on the seat of the vehicle.

The first processing unit may determine the driving mode as a stop mode, a low-speed driving mode, a first acceleration driving mode, and a second acceleration driving mode based on speed information and acceleration information included in the vehicle traveling information.

The third processing unit may control the vibration signal of the vibrator according to object recognition information of the sensor unit.

According to the present disclosure, a method performed by a computing device including at least one processor and a memory storing at least one program executed by the at least one processor may include steps of: determining, by the at least one processor, a driving mode of a vehicle using vehicle traveling information of a sensor unit; analyzing, by the at least one processor, a heart rate variability of an occupant using biometric information about the occupant collected from a biometric information collection unit; and controlling, by the at least one processor, a vibration signal of a vibrator provided on a seat of the vehicle using the driving mode and the heart rate variability.

According to another aspect of the present disclosure, there is provided a method performed by a computing device including one or more processors and a memory storing one or more programs executed by the one or more processors, including, by the processor, determining a driving mode of a vehicle using vehicle traveling information of a sensor unit, analyzing a heart rate variability of an occupant using biometric information about the occupant collected from a biometric information collection unit, and controlling a vibration signal of a vibrator provided on a seat of the vehicle using the driving mode and the heart rate variability.

In the determining of the driving mode, the driving mode of the vehicle may be determined using speed information and acceleration information included in the vehicle traveling information.

In the controlling of the vibration signal, a vibration characteristic of the vibrator may be determined based on the driving mode and the heart rate variability.

In the controlling of the vibration signal, a vibration frequency, a vibration magnitude, and a vibration time of the vibrator may be determined depending on the driving mode and the heart rate variability.

In the controlling of the vibration signal, the vibration characteristic of the vibrator may be adjusted according to a weight of the occupant.

In the controlling of the vibration signal, the vibration characteristic may be adjusted based on a content signal transmitted to the occupant.

In the controlling of the vibration signal, an output range of the vibration characteristic may be set according to the content signal.

In the controlling of the vibration signal, vibration characteristics of a plurality of vibrators provided on the seat of the vehicle may be independently controlled.

In the determining of the driving mode, the driving mode may be determined as a stop mode, a low-speed driving mode, a first acceleration driving mode, and a second acceleration driving mode based on speed information and acceleration information included in the vehicle traveling information.

In the controlling of the vibration signal, the vibration signal of the vibrator may be controlled according to object recognition information of the sensor unit.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view illustrating that a vehicle transmits and receives data by communicating with another device;

FIG. 2 is a diagram showing modules constituting a vehicle according to one embodiment of the present disclosure;

FIG. 3 is a view for describing an environment for providing virtual environment driving content according to the embodiment;

FIGS. 4 and 5 are views for describing a concept of virtual environment driving content according to the embodiment;

FIG. 6 is a view for describing an operation of a vibrator according to the embodiment;

FIG. 7 is a diagram for describing an operation of the vehicle according to the embodiment;

FIG. 8 is a diagram for describing a configuration of a third processing unit according to the embodiment;

FIGS. 9 to 12, 13A-13B, and 14 are views for describing an operation of the third processing unit according to the embodiment; and

FIG. 15 is a flowchart of a method of controlling a vehicle according to an embodiment.

### DETAILED DESCRIPTION OF EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, preferred embodiments of the present disclosure will be described in detail with reference to the accompanying drawings.

However, the technical idea of the present disclosure is not limited to some embodiments to be described but may be implemented in various different forms, and within the scope of the technical idea of the present disclosure, one or more among components in the embodiments may be used by being selectively combined and substituted.

Further, unless specifically defined and described, terms used in the embodiments of the present disclosure (including technical and scientific terms) may be interpreted as meanings which are generally understood by those skilled in the art to which the present disclosure pertains, and commonly used terms such as terms defined in the dictionary may be interpreted in consideration of the contextual meaning of the related art.

The terms used in the embodiments of the present disclosure are for the purpose of describing the embodiments only and are not intended to limit the disclosure.

In the present specification, the singular forms may include the plural forms unless the context clearly dictates otherwise, and when described as “at least one (or one or more) among A, B, and (or) C,” it may include one or more of all possible combinations of A, B, and C.

In addition, in describing a component of embodiments of the present disclosure, terms such as first, second, A, B, (a), (b), etc., may be used.

These terms are only for distinguishing the component from other components, and the essence, sequence, or order of the component is not limited by the terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” of another component, the term “on (above) or under (below)” includes not only when two components are in direct contact with each other, but also when one or more of other components are formed or disposed between the two components. Further, when a component is described as being “on (above) or below (under),” the description may include the meanings of an upward direction and a downward direction based on one component.

Hereinafter, embodiments will be described in detail with reference to the accompanying drawings, but identical or corresponding components are denoted by the same reference numerals regardless of figure numbers, and redundant descriptions thereof will be omitted.

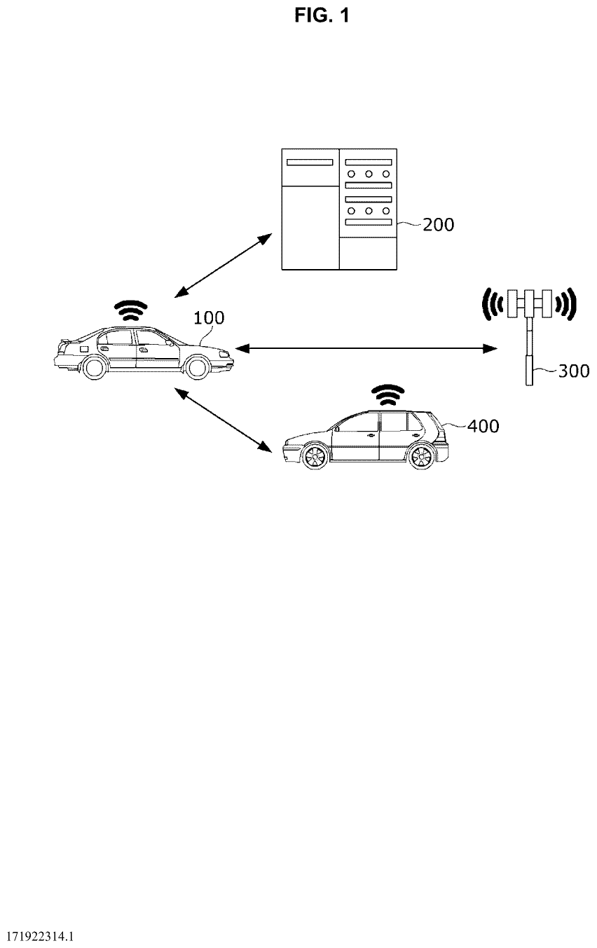

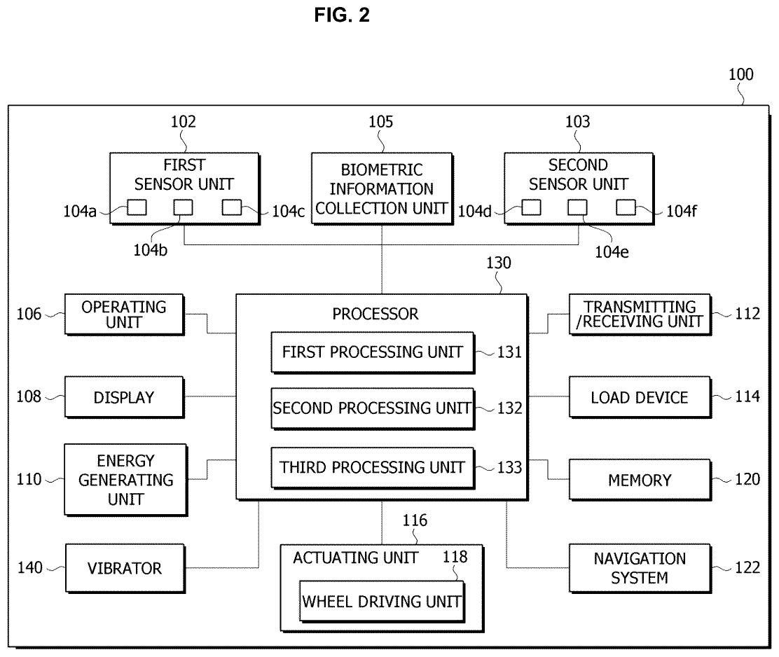

FIG. 1 is a view illustrating that a vehicle transmits and receives data by communicating with another device, and FIG. 2 is a diagram showing modules constituting a vehicle according to one embodiment of the present disclosure. Referring to FIGS. 1 and 2, the vehicle will be described. FIG. 1 is a view illustrating that a vehicle transmits and receives data by communicating with another device.

Referring to FIG. 1, the vehicle 100 may be driven based on electrical energy or fossil energy. In the case of electrical energy, the vehicle 100 may be, for example, a pure battery-based vehicle powered only by a high-voltage battery, or may employ a gas-based fuel cell as an energy source. In addition, the fuel cell may use various types of gas capable of generating electrical energy, and the vehicle 100 may be filled with the gas in a liquefied state, for example. Here, the gas may be hydrogen as one example. However, the gas is not limited thereto, and various gases are applicable. In the case of fossil energy, the vehicle 100 is driven based on fuel such as gasoline, diesel or liquefied gas, and may be equipped with an internal combustion engine that drives an actuating unit 116 by combustion of the fuel. The engine may be included in an energy generating unit 110 in terms of providing a driving rotational force of wheels to a wheel driving unit 118. As another example, the vehicle 100 may drive the actuating unit 116 by selectively utilizing energy from a fossil energy-based internal combustion engine and an electric battery, and may be a hybrid type vehicle.

The vehicle 100 may refer to a movable device. The vehicle 100 is a ground vehicle that travels on the ground and may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like. Here, the ground vehicle may be referred to as including a vehicle that moves underground as well as a vehicle that moves over land. The vehicle 100 may be a robot in a broad sense, such as a means of movement, and the robot may be moved using wheels, tracks, or other movement modules. In the present disclosure, ground mobility devices such as ground vehicles are mainly described, but unless otherwise inconsistent with the present disclosure, the present embodiment may also be applied to air mobility devices such as AAMs, aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be provided as autonomous movement in which a processor 130 of the vehicle 100 takes full control without user intervention, even when a driving situation is uncertain. Semi-autonomous driving may be provided as autonomous movement that requires driver intervention depending on specific driving situations. Semi-autonomous driving may be implemented so that the processor 130 transfers control to a user while deactivating autonomous driving when the aforementioned situation occurs, allowing the user to perform manual driving. According to the levels of autonomous driving defined by the Society of Automotive Engineers (SAE), semi-autonomous driving may correspond to autonomous driving levels 1 to 4, and fully autonomous driving may correspond to level 5.

Meanwhile, the vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or provided to service autonomous driving, and may receive connected data of the vehicle 100 or transmit data necessary for autonomous driving. The server 200 may transmit various information and software modules used to control the vehicle 100 to the vehicle 100 in response to the request and data transmitted from the vehicle 100 and the user device to support autonomous driving and various services of the vehicle 100.

The ITS device 300 may be, for example, a roadside unit (RSU), and the ITS device 300 may assist the user in driving his or her own vehicle or support autonomous driving of the vehicle 100 by exchanging vehicle recognition data, driving control and state data, environmental data around the vehicle, map data, or the like, through vehicle-to-infrastructure (V2I) communication with the vehicle 100. The vehicle 100 may support manual driving or autonomous driving by exchanging the data listed above through V2V with the other vehicle 400.

The vehicle 100 may communicate with other vehicles or other devices based on cellular communication, wireless access in vehicular environment (WAVE) communication, dedicated short range communication (DSRC), or short-range communication, or other communication methods.

For example, the vehicle 100 may use a cellular communication network such as LTE or 5G, WiFi communication network, WAVE communication network, or the like, for communication with the server 200, the ITS device 300, and the other vehicle 400. For another example, DSRC or the like used in the vehicle 100 may be used for communication between vehicles. The communication method between the vehicle 100, the server 200, the ITS device 300, the other vehicle 400, and the user device is not limited to the above-described embodiment.

FIG. 2 is a diagram showing modules constituting a vehicle according to one embodiment of the present disclosure.

The vehicle 100 may include a sensor unit 102, an operating unit 106, a display 108, a load device 114, and a transmitting/receiving unit 112.

The sensor unit 102 may be provided with various types of detectors to detect various states and situations occurring in an external environment, an internal system, a user operation, and a boarding space of the vehicle 100.

Specifically, a first sensor unit 102 may be provided with an externally oriented camera 104a, a lidar sensor 104b, a radar sensor 104c, and the like, to recognize dynamic and static objects existing outside the vehicle 100. The camera 104a may recognize an external object as an image while the vehicle 100 is in use, generate image data, and transmit the image data to the processor 130. The lidar sensor 104b may generate point cloud data as recognized data of the external object and transmit the point cloud data to the processor 130 to generate 3D spatial information that identifies at least a shape of the external object. In order to ascertain the presence of an external object and its relative distance, speed, direction, or the like, the radar sensor 104c may emit radio waves of a specific frequency around the vehicle 100 and generate radar data through radio waves reflected from the external object. In the present disclosure, the sensor unit is illustrated as having the lidar sensor 104b, but in other examples, the lidar sensor 104b may not be mounted.

The first sensor unit 102 may generate object recognition information based on sensing data. Object recognition information may include information on the existence of an object, position information about the object, information on a distance between the vehicle 100 and the object, and information on a relative speed between the vehicle 100 and the object. In the embodiment, external objects may be various objects related to the operation of the vehicle 100.

A second sensor unit 103 may be provided with a positioning sensor 104d, a wheel sensor 104e, an attitude sensor 104f, and the like, to confirm its own location, speed, driving attitude, and the like. The attitude sensor 104f may include a gyro sensor, an angular velocity sensor, an acceleration sensor, or the like. The attitude sensor may be an inertial measurement unit (IMU) sensor and may be equipped with a 3-axis accelerometer and a 3-axis gyroscope. The attitude sensor may measure acceleration in a traveling direction (x), acceleration in a lateral direction (y), acceleration in a height direction (z) of the vehicle 100, and a yaw, a pitch, and a roll as the angular velocity of the vehicle.

The second sensor unit 103 may generate vehicle traveling information based on sensing data. The vehicle traveling information may be information generated based on data detected by various sensors installed inside the vehicle. For example, the vehicle traveling information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like.

In addition, the vehicle traveling information may include route information. The route information may refer to information generated based on a destination input by a vehicle user through the operating unit 106. The route information may refer to information that indicates a traveling route from a current vehicle position to a destination on a map when the destination has been set. When no destination is set, the route information may refer to information including a road on which a host vehicle is currently traveling and a future driving route including the road.

A biometric information collection unit 105 may be provided in a head mounted device and a vibration seat to collect biometric information about an occupant experiencing virtual environment driving content.

The biometric information collection unit 105 may be provided in the vibration seat to measure a heart rate of the occupant.

The biometric information collection unit 105 may be provided inside a vibration seat 20. The biometric information collection unit 105 may be configured to include at least one of a photoplethysmography (PPG) sensor, an electrocardiography (ECG) sensor, and an acoustic sensor.

The PPG sensor may include a light emitting diode (LED) and a light sensor. The PPG sensor may measure the amount of blood using light. The PPG sensor may measure the heart rate in a principle in which light from the LED is shined onto the skin and the amount of light reflected as the shined light passes through the skin and blood vessels varies depending on the amount of blood.

The ECG sensor may include electrodes attached to the skin and a signal processing circuit. The ECG sensor may detect the electrical activity that occurs when the heart beats through the electrodes attached to the skin.

The acoustic sensor may include a high-sensitivity microphone and a signal processing system. The acoustic sensor may measure the heart rate by recording the sound of the heartbeat using the microphone and analyzing the sound.

In addition, the biometric information collection unit 105 may be provided on a back rest and a seat bottom of the vehicle seat to measure the weight of the occupant.

The operating unit 106 may be configured as a module controlled by the user for driving. For example, the operating unit 106 may be a steering wheel for manual driving, an automatic or manual shift transmission, an accelerator pedal, a brake pedal, or the like. The operating unit 106 may be further provided with an interface for enabling or disabling an autonomous driving mode and selecting detailed functions requested by the user so that the user may use the autonomous driving function. In order to receive various requests related to autonomous driving, the operating unit 106 may be configured, for example, as a hard-type interface provided at a predetermined position inside the vehicle 100, or as a soft-type interface that capable of being touched on the display 108. Depending on the specifications of the autonomous vehicle, at least one of the steering wheel, the transmission, and the pedal may be omitted. For another example, the operating unit 106 may be provided with a module that receives a user's control request for the load device 114 in addition to driving control.

The display 108 may function as a user interface. The display 108 may output and display an operating state, a control state, route/traffic information, remaining energy amount information, content requested by the driver, or the like, of the vehicle 100 by the processor 130. In addition, the display 108 may be configured as a touch screen capable of detecting driver input to receive a driver's request to instruct the processor 130.

The load device 114 is mounted on the vehicle 100 and may be a type of non-driving electric device excluding a driving power system such as the wheel driving unit 118 or the like. The load device 114 is an auxiliary device that receives electric power from the energy generating unit 110, and may be, for example, an air conditioning system, a lighting system, a seat system, various devices installed in the vehicle 100, or the like. In the present disclosure, a cooling/heating system that cools or heats at least one of the battery, the fuel cell, the internal combustion engine, the air conditioning system, and a specific part of the vehicle 100 may be further included.

The transmitting/receiving unit 112 may support mutual communication with the server 200, the ITS device 300, surrounding vehicles 300, and the like. The transmitting/receiving unit 112 may include a module that processes, for example, cellular communication, WAVE, DSRC communication, and the like. In the present disclosure, the transmitting/receiving unit 112 may transmit data generated or stored while driving to the server 200 and receive data and software modules transmitted from the server 200. The transmitting/receiving unit 112 may support communication with an electronic device carried by an occupant inside the vehicle 100. In the present disclosure, the vehicle 100 may transmit and receive data utilized in a method according to the present disclosure to the outside through the transmitting/receiving unit 112.

For example, the transmitting/receiving unit 112 may receive traffic signal information from a traffic signal controller and provide the traffic signal information to the processor 130. In addition, the transmitting/receiving unit 112 may receive a control signal from the traffic signal controller and provide the control signal to the processor 130.

In addition, the vehicle 100 may include an energy generating unit 110 and an actuating unit 116.

The energy generating unit 110 may generate and supply power and electric power used in a driving power system and a non-driving power system, such as the actuating unit 116. The non-driving power system may be, for example, the sensor unit 102, the operating unit 106, the display 108, the load device 114, and the transmitting/receiving unit 112, but is not limited thereto, and may include various components that implement sensing, interface, communication, and convenience functions, excluding components directly involved in driving operations. When the vehicle 100 is driven based on electrical energy, the energy generating unit 110 may be configured as an electric battery charged from the outside, or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen. When the vehicle 100 is driven based on fossil energy, the energy generating unit 110 may be configured as the internal combustion engine. In addition, when the vehicle 100 is a hybrid type, the energy generating unit 110 may be provided as a combination of the internal combustion engine and the electric battery.

The actuating unit 116 may be provided with at least one module that implements driving operations and perform at least one driving operation among longitudinal control such as acceleration and deceleration and lateral control such as steering, according to a user request from the operating unit 106. In order to perform driving operations according to a command of the processor 130 by a manual operation of the user or autonomous driving, the actuating unit 116 may be provided with the wheel driving unit 118 and mechanical components and electronic modules for implementing the driving operations in the wheel driving unit 118. When the vehicle 100 is operated based on electric energy, the actuating unit 116 may include an assembly for transmitting the requested driving operation to the wheel driving unit 118. When the vehicle 100 is operated based on fossil energy, the actuating unit 116 may be provided with a transmission and a gear module that transmit the power of the internal combustion engine.

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further have a regenerative braking function.

A navigation unit 122 may provide navigation information. The navigation information may include at least one of map information, set destination information, route information according to a set destination, information on various objects on the route, lane information, and current vehicle position information.

The navigation unit 122 may receive information from an external device through the transmitting/receiving unit 112 and update previously stored information. According to the embodiment, the navigation unit 122 may be classified as a sub-component of the operating unit 106.

In addition, the vehicle 100 may include a memory 120 and a processor 130.

The memory 120 may store applications and various data for controlling the vehicle 100 and load applications or read and record data by a request of the processor 130.

The processor 130 may perform overall control of the vehicle 100. The processor 130 may be configured to execute applications and instructions stored in the memory 120.

In the embodiment, each component may have different functions and capabilities in addition to those described below, and additional components may be included in addition to those described above. In addition, in one embodiment, each component may be implemented by using one or more physically separated devices, or may be implemented by one or more processors 130 or a combination of one or more processors 130 and software, and may not be clearly distinguished in specific operations, unlike the illustrated example.

The memory 120 may include a database (DB). In addition, the memory 120 may be a storage medium (non-transitory storage medium) that stores instructions executed by the processor 130. The memory 120 may include at least one of storage media such as s random access memory (RAM), a static random access memory (SRAM), a read only memory (ROM), a programmable read only memory (PROM), an electrically erasable and programmable ROM (EEPROM), an erasable and programmable ROM (EPROM), a hard disk drive (HDD), a solid state disk (SSD), an embedded multimedia card (eMMC), a universal flash storage (UFS), and/or a web storage.

In the embodiment, a first processing unit 131, a second processing unit 132, and a third processing unit 133 may be implemented through the same process, and for convenience of description, the operation of each component will be described separately below.

The processor 130 may include at least one of processing devices such as an application specific integrated circuit (ASIC), a digital signal processor (DSP), a programmable logic device (PLD), a field programmable gate array (FPGA), a central processing unit (CPU), a microcontroller, and/or a microprocessor 130.

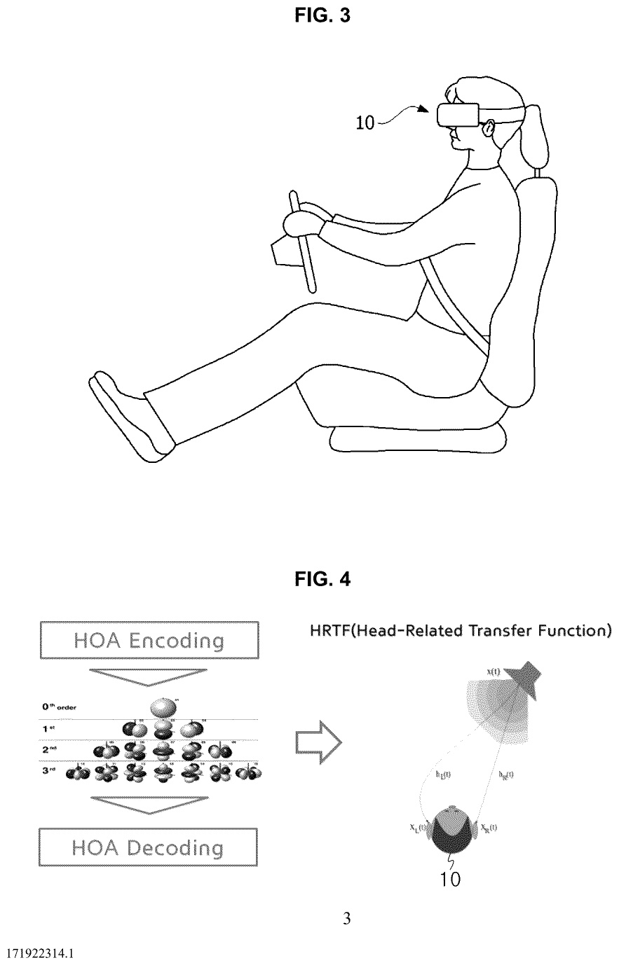

FIG. 3 is a view for describing an environment for providing virtual environment driving content according to the embodiment. Referring to FIG. 3, virtual content according to the embodiment may be applied to a user of an autonomous vehicle who experiences virtual environment content while wearing a head-mounted display (HMD) in a metaverse environment or the like.

In the embodiment, a head mounted device 10 may refer to a display device that is disposed in the vehicle and worn on a user's head. The head mounted device 10 may be primarily used in virtual reality (VR) and augmented reality (AR) applications, and may provide an immersive visual experience by disposing a display in front of user's eyes.

The head mounted device 10 may include a display panel that provides images to the user using two small screens or one large screen, and a lens positioned between the display and the user's eyes to adjust the images to the eyes.

The head mounted device 10 may adjust a field of view of the screen by tracking a user's head movement using head tracking technology implemented through a gyroscope, accelerometer, magnetic field sensor, and the like.

The head mounted device 10 may provide virtual environment driving content to the user wearing the head mounted device. In the embodiment, the virtual environment driving content may include virtual images and virtual sounds generated based on a driving environment of a vehicle driver.

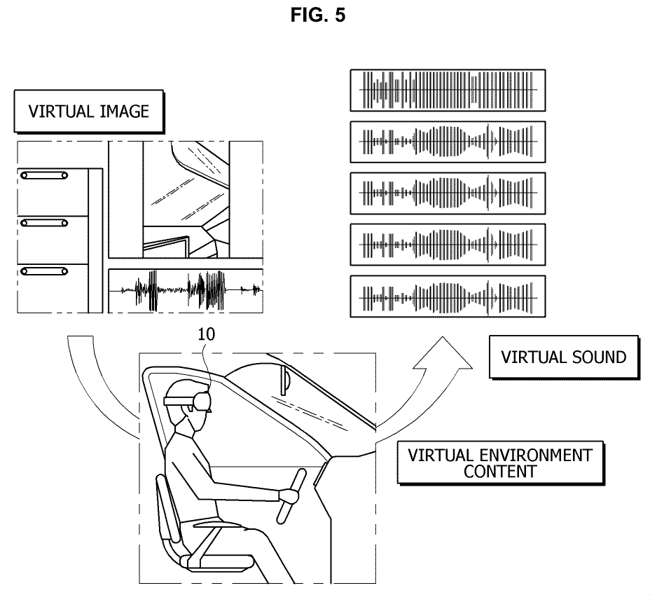

FIGS. 4 and 5 are views for describing a concept of virtual environment driving content according to the embodiment. Referring to FIGS. 4 and 5 together, a virtual image may refer to data generated by visualizing an external background that a driver or occupant of a vehicle may actually experience through a vehicle window while a vehicle is traveling.

In addition, the virtual sounds may include various noises and music that may be perceived by the driver or occupant of the vehicle inside the vehicle while the vehicle is traveling.

For example, the virtual sound may include higher-order ambisonics.

In the embodiment, by considering user personalization, the virtual environment driving content may apply the difference in sound perception according to the structure and shape of the head and ears as the head-related transfer function (HRTF) logic of a three-dimensional sound implementation filter concept, thereby reducing the dispersion of virtual image and virtual sound fidelity. Higher-order ambisonics is a method capable of reproducing three-dimensional sound by arranging speaker devices in a spherical shape centered on a listener, and by the higher-order ambisonics, a sense of difference caused by image-to-sound inaccuracy may be improved and realistic sounds may be implemented.

The HRTF logic may change sound waves traveling toward the listener from a sound source located at a specific azimuth and elevation angle into sound waves having characteristics necessary for directional perception due to the shape of the body, such as the shape of the head, structure of the auricle, and shape of the shoulder of each individual through which the sound waves pass to reach the listener's ears. The HRTF logic may measure the characteristics that cause the changes and express the measured characteristics in the form of a transfer function. Since the shape of the body greatly varies from person to person, each person's HRTF is bound to be different. Therefore, in order to accurately use the HRTF, a customized HRTF tailored to each individual user is required. However, in order to obtain HRTF data, measurements have to be made at both a determined azimuth and elevation. It is not realistically possible to measure HRTFs for all users since the equipment required to perform the measurements is complex and the measurements take a long time. Therefore, in general, signal processing for producing binaural sound sources may be performed using the HRTF characteristics of a standard KEMAR dummy head or the characteristics in the public HRTF database of subjects provided by research institutes such as ARI, CIPIC, IRCAM, and the like.

The higher-order ambisonics is a technology for applying panning, which is a technique that adjusts the location of sound in a virtual space, to the inside or outside of a sphere, beyond the surface of the sphere. A spherical wave may be expressed as a sum of spherical harmonic functions. Using the spherical wave, a sound wave expressed by the spherical harmonic function may be reproduced through each speaker and by adding the sound waves, a sound wave identical to that output from a virtual sound source desired by the user may be created. Lower-order ambisonics that uses a small number of spherical harmonic functions may not create a large-scale sound field, but forms a very small area of a sweet spot that is a location where the user may accurately perceive the virtual sound field. To overcome the very small area of the sweet spot, higher-order ambisonics technology is being applied. The minimum number of speakers required to implement n-th order ambisonics technology may be defined as (n+1) 2.

When the virtual environment driving content is executed, the user may perceive virtual images and virtual sounds, and a virtual environment motion sickness occurrence determination device according to the embodiment may analyze a motion sickness correlation due to sensory conflict through biometric information analysis. The Vehicle 100 may calculate a motion sickness determination quantitative index through the virtual environment fidelity analysis of a user who experiences the virtual environment driving content in a state of sitting on the vibration seat 20 and wearing the head mounted device 10.

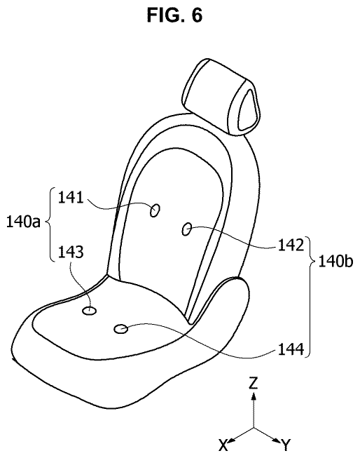

FIG. 6 is a view for describing the operation of a vibrator 140 according to the embodiment. Referring to FIG. 6 together, the vibrator 140 is provided on a back rest and a seat bottom of a seat and may independently output a vibration signal. The vibrator 140 may be disposed to be embedded in an empty space of the back rest and the seat bottom of the seat, and two vibrators 141 and 142 may be disposed on the back seat and two vibrators 143 and 144 may be disposed on the seat bottom at predetermined intervals. Each of the vibrators 141 to 144 operates independently under the control of the processor 130 and may output a predetermined vibration signal.

Each vibrator 140 may be provided in a form that includes a frame forming an exterior, a voice coil installed inside the frame that forms a magnetic field when an electrical signal is applied, at least one magnet that vibrates with a certain frequency by interacting with the magnetic field of the voice coil, a vibrating body that transmits vibration of the magnet to the human body, and the like. When an electrical signal is applied to the voice coil of the vibrator 140 according to the control of the processor, a magnetic field proportional to the intensity of the electrical signal is formed in the voice coil, and as the magnetic field interacts with the magnet, the magnet vibrates in an up-and-down direction at a predetermined frequency. As the vibration signal is output through the vibrating body and transmitted to the human body, the human body recognizes a predetermined acoustic signal.

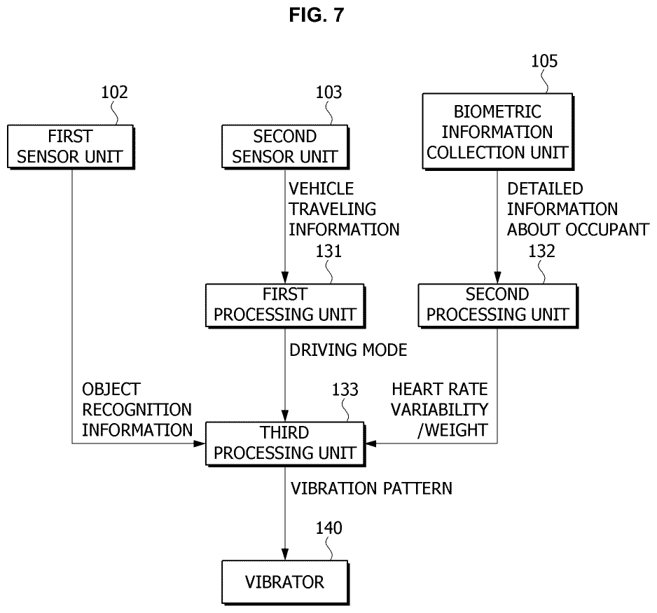

FIG. 7 is a diagram for describing the operation of the vehicle according to the embodiment. Referring to FIG. 7 together, the first processing unit 131 may determine a driving mode of the vehicle using vehicle traveling information of the second sensor unit 103. The first processing unit 131 may determine the driving mode of the vehicle using speed information and acceleration information included in the vehicle traveling information.

The first processing unit 131 may determine the driving mode as a stop mode, a low-speed driving mode, a first acceleration driving mode, and a second acceleration driving mode based on the speed information and acceleration information included in the vehicle traveling information. The first acceleration driving mode may refer to a driving mode in which the acceleration is lower than that of the second acceleration driving mode.

The second processing unit 132 may analyze an occupant's heart rate variability using biometric information about the occupant collected from the biometric information collection unit 105. The second processing unit 132 may analyze an occupant's heart rate, heartbeat characteristic, and values of standard deviation of NN intervals (SDNN).

The heart rate may refer to the number of heartbeats per minute and may be measured in units of bpm (beats per minute).

The heart rate characteristic refers to the variation of heart rate over time, which may include heart rhythm, periodicity, and variability. A heart with normal rhythm (normal sinus rhythm) beats at regular intervals, while a heart with irregular rhythm (arrhythmia) may beat at irregular intervals.

The SDNN is one of the indicators for measuring heart rate variability (HRV). Here, “NN intervals” refers to the normal R-R interval, and the R-R interval may refer to the time between the R waves (R peaks) of two consecutive heartbeats in an electrocardiogram. The SDNN reflects the activity of the heart's autonomic nervous system. For example, a high SDNN indicates an active autonomic nervous system and good heart health, while a low SDNN indicates a decreased autonomic nervous system or possible heart health problems.

For example, the second processing unit 132 may determine that the risk of virtual environment motion sickness is low and the occupant is in a normal state when the heart rate is 60 to 100 bpm, the heartbeat characteristic is regular, and the SDNN value is 3 or higher. Alternatively, the second processing unit 132 may determine that the risk is at a medium level that is an alert level when the heart rate is outside the range of 60 to 100 bpm, the heartbeat characteristic is irregular, or the SDNN value is less than 3. Alternatively, the second processing unit 132 may determine that the risk of virtual environment motion sickness is at a high risk level when two or more of a case where the heart rate is outside the range of 60 to 100 bpm, a case where the heartbeat characteristic is irregular, or a case where the SDNN value is less than 3 occur.

In addition, the second processing unit 132 may analyze an occupant's weight using the biometric information about the occupant collected from the biometric information collection unit 105. The second processing unit 132 may analyze the occupant's weight by position, and determine the occupant's seating posture through the analysis.

The third processing unit 133 may control a vibration signal of the vibrator 140 provided on the seat of the vehicle using the driving mode and heart rate variability.

The third processing unit 133 may independently control vibration characteristics of a plurality of vibrators 141 to 144 provided on the seat of the vehicle.

The two vibrators 140 may be applied to each of the seat bottom where the occupant's thighs rest and the back rest where the occupant's back rests and vibrate in an up-down direction (Z) of a lower part and a forward-backward direction (X, Y) of the back.

When the vehicle is traveling at a constant speed, the vibration characteristic may have the amount of vibration determined by the speed and acceleration, and the vibration by the constant speed may have a slope close to linear. Accordingly, the third processing unit 133 may provide a vibration shock characteristic so that a driver may feel a sense of speed when the vehicle is traveling at the constant speed.

A vibration shock characteristic due to the virtual sound volume change when the vehicle is accelerating may have the amount of vibration determined by the speed and acceleration, and the third processing unit 133 may calculate the sound volume of the virtual content and a X-direction/Z-direction vibration excitation force.

The third processing unit 133 may calculate the virtual sound and vibration characteristic based on speed and acceleration, depending on constant speed or acceleration.

The third processing unit 133 may improve the riding comfort by controlling the vibrator 140 when an artificially generated shift signal is input in a way that increases the shift feel of the vehicle.

To this end, when the artificial shift signal is input, the third processing unit 133 may provide an impact signal to the vibrator 140 mounted inside the seat to implement the vibration shock that occurs when a general transmission shifts.

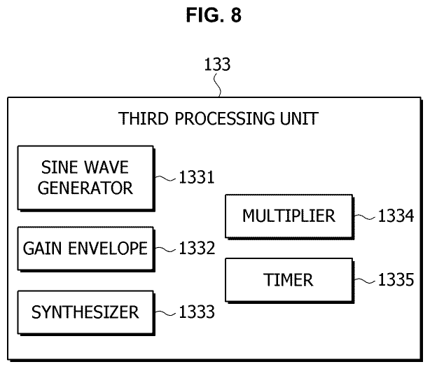

FIG. 8 is a diagram for describing a configuration of the third processing unit according to the embodiment. Referring to FIG. 8 together, the third processing unit 133 may generate a vibration characteristic using a sine wave generator 1331, a gain envelope 1332, a synthesizer 1333, a multiplier 1334, and a timer 1335.

The sine wave generator may determine a frequency value of the vibrator 140, the gain envelope may optimize a vibration magnitude and a vibration time of the vibrator 140, and the timer may determine a vibration delay value of the vibrator 140. Through the configuration, the third processing unit 133 may generate a vibration characteristic that may independently control each of the vibrators 141 to 144.

The third processing unit 133 may determine the vibration characteristic of the vibrator 140 based on the driving mode and heart rate variability. The third processing unit 133 may determine a vibration frequency, a vibration magnitude, and a vibration time of the vibrator 140 depending on the driving mode and heart rate variability.

The third processing unit 133 may control the operation of the vibrator 140 in a direction for minimizing motion sickness of the occupant depending on the driving mode and heart rate variability. That is, in order to reduce motion sickness, the third processing unit 133 may control the vibration characteristic so that the excitation intensity of the low-frequency band is lowered and variable control is possible in conjunction with heart rate variability.

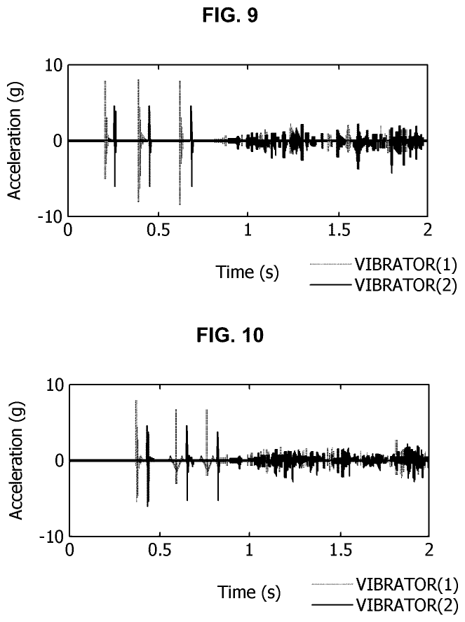

FIGS. 9 to 14 are views for describing the operation of the third processing unit according to the embodiment.

Referring to FIG. 9 together, the third processing unit 133 may implement a vibration characteristic for reducing motion sickness by controlling the vibrator 140 to be close to the feeling of idling vibration of an internal combustion engine vehicle in a stop mode in which there are no engine idling and no virtual content output.

In the stop mode, the third processing unit 133 may impart initial peak vibration several times at start-up, but may also provide a time delay between a first vibration unit 140a located on the left side and a vibration unit located on the right side based on an occupant's body center line.

That is, the third processing unit 133 may impart the peak vibration similar to the vibration when the internal combustion engine is started to give a signal that the vehicle has started in a first section of the stop mode.

In a second section of the stop mode, the third processing unit 133 may impart a synchronized vibration characteristic by removing the time delay between the first vibration unit 140a and a second vibration unit 140b so that the engine idling vibration of an internal combustion engine vehicle may be imparted while the vehicle is stopped after the engine has been started.

The third processing unit 133 may control the first vibration unit 140a and the second vibration unit 140b to simultaneously have a regular vibration characteristic in a weak vibration characteristic in the second section of the stop mode and perform frequency and amplitude analysis by selecting a climax section.

Referring to FIG. 10 together, in a low-speed driving mode, the third processing unit 133 may implement a pattern similar to a traffic jam situation in urban driving where stopping and driving are repeated as the vibration characteristic. At the beginning of the low-speed driving mode, the third processing unit 133 may not impart a vibration characteristic and may impart a first vibration characteristic only while the vehicle is traveling in a constant-speed section.

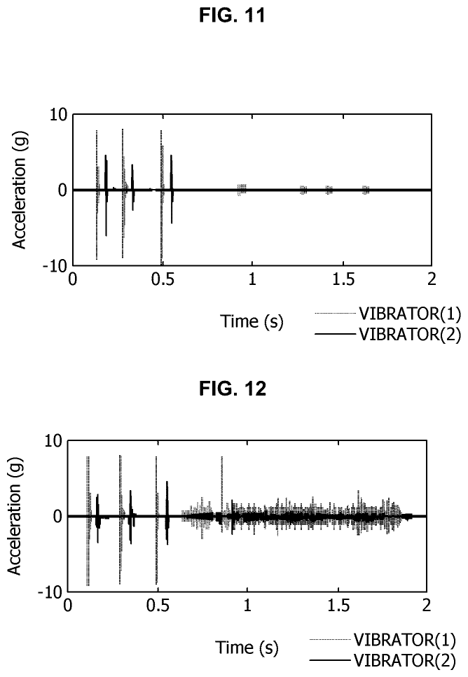

Referring to FIG. 11 together, in a first acceleration driving mode, for example, the third processing unit 133 may implement a speed change pattern close to a country road/national road driving pattern as the vibration characteristic. The third processing unit 133 may impart a second vibration characteristic having a time delay between the first vibration unit 140a and the second vibration unit 140b several times for an impactful vibration in an initial acceleration section of the first acceleration driving mode, and may not impart the vibration characteristic in subsequent sections.

In the embodiment, the first vibration characteristic may refer to a vibration characteristic having a vibration frequency and a vibration magnitude that are relatively smaller than those of the second vibration characteristic.

Referring to FIG. 12 together, the third processing unit 133 may implement an acceleration and overtaking pattern as the vibration characteristic in a second acceleration driving mode that is close to a highway driving pattern. The third processing unit 133 may initially impart a third vibration characteristic proportional to acceleration in a first section of the second acceleration driving mode. However, since an excessive vibration characteristic may cause motion sickness to the occupant, a limit on the vibration characteristic may be set through filter processing as described below.

In a second section of the second acceleration driving mode, the third processing unit 133 may impart a post-vibration characteristic that imparts acceleration feeling vibration so that no sense of difference occurs in the accelerator pedal response after rapid acceleration. In this case, the third processing unit 133 may perform control such that cross vibration is imparted by setting the time delay between the vibration characteristics of the first vibration unit 140a and the second vibration unit 140b in the first section, but a synchronized vibration characteristic is output in the following second section. In addition, in a third section, the third processing unit 133 may impart the first vibration characteristic to the first vibration unit 140a and impart the second vibration characteristic to the second vibration unit 140b.

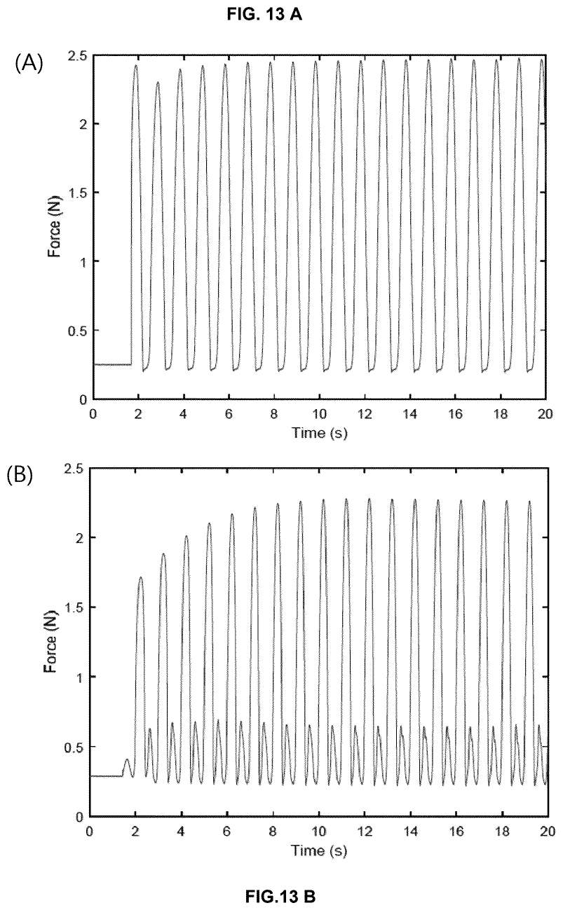

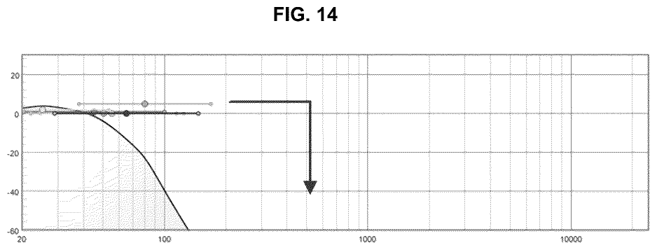

Referring to FIGS. 13A-13B, the third processing unit 133 may adjust the vibration characteristic depending on the heart rate and heartbeat characteristic of the heart rate variability. The third processing unit 133 may adjust the vibration characteristic in a direction in which a motion sickness index does not exceed a threshold value depending on the biometric information about the occupant collected in real time. The third processing unit 133 may adjust a vibration frequency depending on the heart rate and adjust the regularity of the vibration characteristic depending on the heartbeat characteristic. That is, the third processing unit 133 may adjust the vibration frequency so that the heart rate does not exceed 60 to 100 bpm. In addition, the third processing unit 133 may adjust the vibration characteristic to have a regular intensity, like (a), or a variable intensity, like (b), so that the heartbeat characteristic maintains regularity.

In addition, the third processing unit 133 may adjust the vibration characteristics of the vibrators 140 according to the weight of the occupant.

When a difference in the left/right or up/down vibration magnitude occurs depending on the weight for each region of the occupant through the biometric information, the third processing unit 133 may reduce the vibration magnitude of the vibrator 140 in a region where the vibration magnitude is transmitted at a relatively high level and increase the vibration magnitude of the vibrator 140 in a region where the vibration magnitude is transmitted at a relatively low level.

In addition, the third processing unit 133 may perform a filtering function to reduce the sense of difference caused by the time delayed vibration between the vibrators 140. The human body has a natural vibration frequency depending on body parts and organs, and when an excitation frequency and the frequency overlaps while the vehicle is traveling, resonance occurs, and the resonance may cause the vibration amplitude to become excessively large, which may cause cyber sickness. Accordingly, the third processing unit 133 may set the vibration frequency so that the vibration frequency does not resonate with the human body resonance frequency or a natural frequency of the sheet. Through the process, the sense of difference between vibrators 140 may be prevented and thus an optimal vibration characteristic may be implemented.

In addition, the third processing unit 133 may adjust the vibration characteristic based on a content signal transmitted to the occupant. The third processing unit 133 may set an output range of the vibration characteristic according to the content signal. The setting may refer to a post-processing process for optimizing the vibration characteristic set through the driving mode and heart rate variability.

The third processing unit 133 may adjust the vibration characteristic by reflecting a vibration damping rate of a lumbar region due to seat vibration by considering ecological characteristics of the occupant's muscles, and referring to the time it takes for the muscle tissue to return to its initial state after the external stress caused by vibration is removed through viscoelastic properties of the muscle tissue. In this way, the vibration characteristic may be determined in a direction that relieves muscle tension.

In addition, excessive vibration or jerking motions such as rapid acceleration, sudden braking, and sudden cornering may cause motion sickness in the occupant. Accordingly, the third processing unit 133 may limit a range of fluctuations through a scaling process that reduces a signal exceeding a certain signal by a certain ratio when the signal is excessively input by utilizing a function of limiting the output range of the vibration characteristic.

That is, the third processing unit 133 may perform optimization control by setting a limit value by limiting excessive vibration through the post-processing process, and for a very small vibration, compensating for the small vibration and performs optimization control, thereby implementing vibration without the sense of difference.

Referring to FIG. 14 together, the third processing unit 133 has a method of applying a limiter when vibration that may be harmful to the human body occurs to prevent the vibration exceeding a certain signal from occurring and has a method of creating a mode map so that vibration excitation is not given or a weak vibration is given in a frequency band to be avoided.

In addition, since imparting a vibration too weakly may cause the sense of difference, the third processing unit 133 may reflect a method of generating a signal when a signal exceeding a certain level occurs in the control logic. When it is desired to give an appropriate acceleration feeling without being excessive in the driving pattern, when a vibration characteristic of a certain magnitude or larger is input, the third processing unit 133 may amplify the vibration characteristic of the certain magnitude or larger to spread the already input vibration characteristic. The third processing unit 133 may perform an operation of spreading the vibration characteristic in conjunction with virtual content.

For example, when a vibration magnitude equal to or higher than an upper threshold of the vibration characteristic is applied to the vibration characteristic for a threshold time or longer, the third processing unit 133 may limit a vibration magnitude value by a certain percentage or limit the duration of the vibration.

In addition, the third processing unit 133 may set an upper limit value of the vibration magnitude so that a vibration magnitude exceeding the threshold is not applied, and may adjust a vibration signal exceeding the upper limit value to converge to the upper limit value.

In addition, the third processing unit 133 may increase the vibration magnitude when a vibration magnitude lower than a lower threshold is applied to the vibration characteristic for the threshold time or longer.

In addition, the third processing unit 133 may control the vibration signal of the vibrator 140 according to object recognition information of the first sensor unit 102. When an object that may be an obstacle to a traveling route of the vehicle is recognized based on the object recognition information, the third processing unit 133 may control the operation of the vibrator 140 by generating a warning signal and converting the warning signal into a vibration characteristic so that the occupant may tactilely recognize the object.

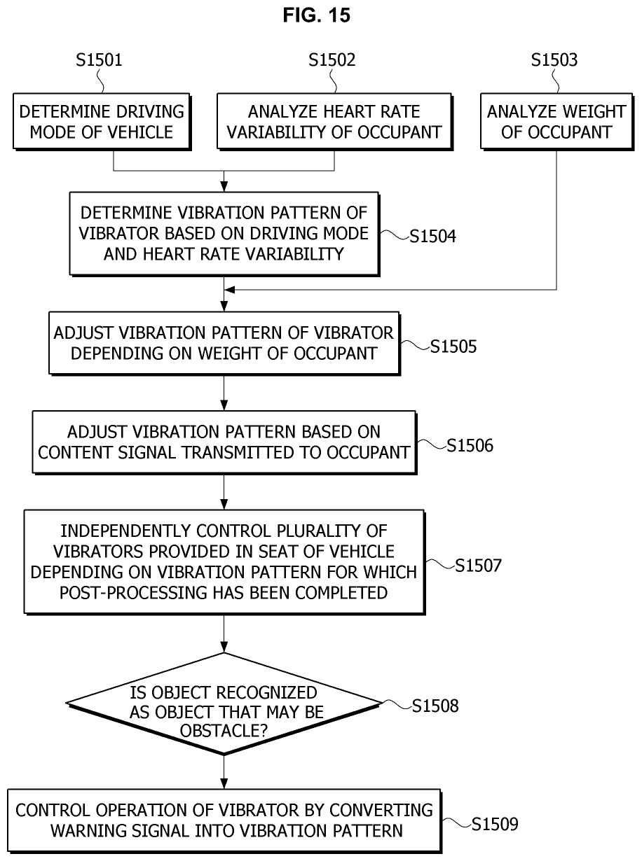

FIG. 15 is a flowchart of a method of controlling a vehicle according to an embodiment.

Referring to FIG. 15, a processor determines a driving mode of a vehicle using vehicle traveling information of a sensor unit. The processor determines the driving mode as a stop mode, a low-speed driving mode, a first acceleration driving mode, and a second acceleration driving mode based on the speed information and acceleration information included in the vehicle traveling information (S1501).

In addition, the processor analyzes an occupant's heart rate variability using biometric information about the occupant collected from a biometric information collection unit. The processor analyzes an occupant's heart rate, heartbeat characteristic, and SDNN values (S1502).

In addition, the processor analyzes the occupant's weight using the biometric information about the occupant collected from the biometric information collection unit. The processor may analyze the occupant's weight by location, and determines the occupant's seating posture through the analysis (S1503).

Next, the processor independently determines vibration characteristics of a plurality of vibrators based on the driving mode and heart rate variability (S1504).

Next, the processor adjusts the vibration characteristics of the vibrators depending on the weight of the occupant. When a difference in the left/right or up/down vibration magnitude occurs depending on the weight for each part of the occupant through the biometric information, the processor reduces the vibration magnitude of the vibrator in a region where the vibration magnitude is transmitted at a relatively high level and increases the vibration magnitude of the vibrator in a region where the vibration magnitude is transmitted at a relatively low level (S1505).

Next, the processor adjusts the vibration characteristic based on a content signal transmitted to the occupant. The processor sets an output range of the vibration characteristic according to the content signal. The setting may refer to a post-processing process for optimizing the vibration characteristic set through the driving mode and heart rate variability (S1506).

Next, the processor independently controls the plurality of vibrators provided in a seat of the vehicle depending on the vibration characteristic for which post-processing has been completed (S1507).

In addition, the processor may control the vibration signal of the vibrator according to the object recognition information of the sensor unit. When an object that may be an obstacle to a traveling route of the vehicle is recognized based on the object recognition information, the processor controls the operation of the vibrator by generating a warning signal and converting the warning signal into a vibration characteristic so that the occupant may tactilely recognize the object (S1508 and S1509).

The term “unit” used in the present embodiment refers to software component or hardware components such as a field-programmable gate array (FPGA) or an application specific integrated circuit (ASIC), and “unit” performs certain functions. However, the “˜unit” is not limited to software or hardware. The “˜unit” may be configured to reside in an addressable storage medium, or may be configured to reproduce one or more processors. Therefore, for example, “unit” includes components such as software components, object-oriented software components, class components, and task components, and includes processes, functions, attributes, procedures, sub-routines, segments of program code, drivers, firmware, micro codes, circuits, data, a database, data structures, tables, arrays, and variables. Functions provided in the components and the “unit” may be coupled with lesser numbers of components and “units,” or may be further divided into additional components and “units.” Furthermore, the components and “˜units” may be implemented to reproduce one or more CPUs in a device or a security multimedia card.

With a vehicle according to an embodiment and a method of controlling the same, it is possible to improve the riding comfort of an occupant while a vehicle is traveling.

In addition, it is possible to reduce the occurrence of motion sickness in the occupant.

In addition, it is possible to reduce motion sickness caused by sensory conflict due to provision of virtual content under a vehicle occupant environment.

Although the preferred embodiments of the present disclosure have been described above, it is understood that those skilled in the art can make various changes and modifications to the present disclosure without departing from the spirit and scope of the present disclosure set forth in the claims below.

What is claimed is:

1. A vehicle including:
at least one processor; and
a memory configured to store at least one program executed by the at least one processor,
wherein the at least one processor is configured to execute the at least one program to:
determine a driving mode of the vehicle using vehicle traveling information of a sensor unit;
analyze a heart rate variability of an occupant using biometric information about the occupant collected from a biometric information collection unit; and
control a vibration signal of a vibrator provided on a seat of the vehicle using the driving mode and the heart rate variability.

2. The vehicle of claim 1, wherein the at least one processor determines the driving mode of the vehicle using speed information and acceleration information included in the vehicle traveling information.

3. The vehicle of claim 2, wherein the at least one processor determines a vibration characteristic of the vibrator based on the driving mode and the heart rate variability.

4. The vehicle of claim 3, wherein the at least one processor determines a vibration frequency, a vibration magnitude, and a vibration time of the vibrator depending on the driving mode and the heart rate variability.

5. The vehicle of claim 3, wherein the at least one processor analyzes a weight of the occupant using the biometric information about the occupant collected from the biometric information collection unit, and
the at least one processor adjusts the vibration characteristic of the vibrator according to the weight of the occupant.

6. The vehicle of claim 3, wherein the at least one processor adjusts the vibration characteristic based on a content signal transmitted to the occupant.

7. The vehicle of claim 6, wherein the at least one processor sets an output range of the vibration characteristic according to the content signal.

8. The vehicle of claim 1, wherein the at least one processor independently controls vibration characteristics of a plurality of vibrators provided on the seat of the vehicle.

9. The vehicle of claim 1, wherein the at least one processor determines the driving mode as a stop mode, a low-speed driving mode, a first acceleration driving mode, and a second acceleration driving mode based on speed information and acceleration information included in the vehicle traveling information.

10. The vehicle of claim 1, wherein the at least one processor controls the vibration signal of the vibrator according to object recognition information of the sensor unit.

11. A method performed by a computing device including at least one processor and a memory storing at least one program executed by the at least one processor, the method comprising:
determining, by the at least one processor, a driving mode of a vehicle using vehicle traveling information of a sensor unit;
analyzing, by the at least one processor, a heart rate variability of an occupant using biometric information about the occupant collected from a biometric information collection unit; and
controlling, by the at least one processor, a vibration signal of a vibrator provided on a seat of the vehicle using the driving mode and the heart rate variability.

12. The method of claim 11, wherein in determining the driving mode, the driving mode of the vehicle is determined using speed information and acceleration information included in the vehicle traveling information.

13. The method of claim 12, wherein in controlling the vibration signal, a vibration characteristic of the vibrator is determined based on the driving mode and the heart rate variability.

14. The method of claim 13, wherein in controlling the vibration signal, a vibration frequency, a vibration magnitude, and a vibration time of the vibrator are determined depending on the driving mode and the heart rate variability.

15. The method of claim 13, wherein in controlling the vibration signal, the vibration characteristic of the vibrator is adjusted according to a weight of the occupant.

16. The method of claim 13, wherein in controlling the vibration signal, the vibration characteristic is adjusted based on a content signal transmitted to the occupant.

17. The method of claim 16, wherein in controlling the vibration signal, an output range of the vibration characteristic is set according to the content signal.

18. The method of claim 11, wherein in controlling the vibration signal, vibration characteristics of a plurality of vibrators provided on the seat of the vehicle are independently controlled.

19. The method of claim 11, wherein in determining the driving mode, the driving mode is determined as a stop mode, a low-speed driving mode, a first acceleration driving mode, and a second acceleration driving mode based on speed information and acceleration information included in the vehicle traveling information.

20. The method of claim 11, wherein in controlling the vibration signal, the vibration signal of the vibrator is controlled according to object recognition information of the sensor unit.
